(19) United States
(12) Patent Application Publication
(10) Pub. No.: US 2024/0132779 A1
(43) Pub. Date: Apr. 25, 2024

(54) PLASTIC PRODUCTS CONTAINING LUMINOPHORES

(71) Applicant: Evonik Operations GmbH, Essen (DE)

(72) Inventors: Matthias NAUMANN, Essen (DE); Kathrin Lehmann, Leverkusen (DE); Simone Schulte, Essen (DE); Christina Janke, Essen (DE)

(73) Assignee: Evonik Operations GmbH, Essen (DE)

(21) Appl. No.: 18/555,015

(22) PCT Filed: Mar. 23, 2022
(86) PCT No.: PCT/EP2022/057612

§ 371 Date: Oct. 12, 2023

(30) Foreign Application Priority Data
Apr. 13, 2021 (EP) 21167978.2

(51) Int. Cl. C09K 11/77; C08K 3/015; C08K 3/34; C09K 11/02

(52) U.S. Cl. CPC C09K 11/77744; C08K 3/015; C08K 3/34; C09K 11/02; C09K 2211/18

(57) ABSTRACT

Plastic products contain at least one synthetic material and at least one luminophore of the general formula (I) Lu_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-e}Zr_{d}Hfₑ)ₐ₊₂ₙO₁₂ (I), where a=0-1, 1≥b>0, d=0-1, e=0-1, n=0-1, z=0-1, u=0-1, and v=0-1, with the proviso that u+v≤1 and d+e≤1. Ln is selected from praseodymium (Pr), gadolinium (Gd), erbium (Er), neodymium (Nd), and yttrium (Y). Objects containing the plastic product and objects made therefrom are also provided.

The invention relates to plastic products comprising a phosphor having antimicrobial character and a plastic, and to articles comprising and/or produced from these plastic products.

Every day, humans are exposed to millions of microorganisms such as bacteria, fungi and viruses. Many of these microorganisms are useful or even necessary. Nevertheless, as well as these less harmful representatives, there are also disease-causing or even deadly bacteria, fungi and viruses.

Microorganisms can be transmitted through daily intercourse with other people and contact with articles that have been used by others. Surfaces are given an antimicrobial finish especially in hygiene-sensitive areas. Fields of use are in particular surfaces of medical devices and consumable articles in hospitals, and in outpatient health and welfare facilities. In addition to these, there are surfaces in the public sphere, in the food and drink sector and in animal keeping. The spread of pathogenic microorganisms is a great problem nowadays in the care sector and in medicine, and wherever humans move in an enclosed space. A particularly high risk at present is the increased occurrence of what are called multiresistant bacteria that are insensitive to the standard antibiotics.

In order to reduce the risk of spread of pathogens over contact surfaces, the contact surfaces are frequently modified with biocides or subjected to chemical or physical treatment. Chemical substances, for example biocides and disinfectants, or the use of physical methods, for example the action of heat, cold, radiation and ultrasound, can kill microorganisms or critically affect the process of reproduction of microorganisms.

Even though chemical and physical methods are extremely effective in the destruction of microorganisms in most cases, they frequently have only a short-lived effect or are unsuitable for some applications under some circumstances since they can lead to destruction of the surfaces treated. Chemical substances can additionally promote the development of resistances. A further disadvantage with the use of chemical substances is the hazardousness thereof to man and the environment. Particular substances, for example formaldehyde, which found use as disinfectant for many years, are now suspected of causing cancer and of being harmful to the environment. A further disadvantage is that disinfection has to be conducted regularly. Alternatively, therefore, active antimicrobial ingredients are integrated into plastic compositions that display their effect as soon as they are released.

DE 10 2005 048 131 A1 describes, for example, a plastic composition comprising a thermoplastic elastomer and at least one active ingredient from the group of the bis(4-substituted-amino-1-pyrdinium)alkanes. This plastic composition shows antimicrobial action. The effect of the composition is based on the release of the active antimicrobial ingredient from the surface of the plastic composition into the environment. Even if the release rate should be low, the release of the active antimicrobial ingredient can lead to endangerment of man and the environment.

WO 2009/013016 A1 describes antimicrobial plastic products containing, as antimicrobially active component, silver orthophosphate or particles of partly reduced silver orthophosphate. It is assumed that the antimicrobial efficacy is based on the release of silver cations at the surface. The plastic used is to have a low release plateau of silver in order to avoid toxic effects. Even if the release rate should be low, the release of the active antimicrobial ingredient can lead to endangerment of man and the environment.

It is likewise known that titanium dioxide particles or other semiconductor particles with an appropriate bandgap can produce active antimicrobial ingredients under the action of light. This exploits the fact that these particles produce free radicals from atmospheric oxygen and (air) humidity under the action of light having a wavelength corresponding to the bandgap of the particles. These free radicals can then diffuse to the bacteria or viruses or render them harmless by free-radical reactions. The free radicals produced thus constitute the active antimicrobial ingredients here. Here too, release of active antimicrobial ingredients thus takes place, which can lead to endangerment of man and the environment. Furthermore, titanium dioxide particles have recently been classified as “likely human carcinogens”, especially in the case of inhalation thereof. However, the oxidative action of free radicals produced by means of photocatalysis with titanium dioxide particles means that they also attack an organic matrix that surrounds them (coating materials or plastics), and so this maintains the restriction here to inorganic or poorly oxidizable matrices (for example in sol-gel technology).

It is likewise known that specific dyes can produce active antimicrobial ingredients. These are dyes that can take on an electronically excited state under the action of light of suitable wavelength by absorbing the energy of a photon. This energy can then be transferred from the dye molecule on contact with atmospheric oxygen to a triplet oxygen molecule (³O₂), which is thus converted to an electronically excited singlet state. The singlet oxygen thus obtained (¹O₂) is a strong oxidizing agent that can kill bacteria or viruses on contact therewith. The singlet oxygen (¹O₂) generated is thus the active antimicrobial ingredient here. Very frequently used for this purpose are polycyclic aromatic dyes that are more resistant to oxidation than other organic dyes. A chemical effect is again exploited on contact with the microorganisms in order to kill them.

The abovementioned semiconductor particles and dyes have at least two major drawbacks when they are embedded in a plastic matrix. The active species that they generate must leave the plastic matrix in order to come into contact with the microorganisms that they can then kill. In this way, the route taken by which the microorganisms are then killed is again chemical and not purely physical. Therefore, such materials are covered by the biocide regulation (Regulation (EU) No 528/2012 of the European Parliament and of the Council of 22 May 2012 in the current text of 2019). The second drawback lies in the simple fact that such materials, when embedded in a plastic matrix, require diffusion processes to produce the active antimicrobial ingredients. For instance, in the case of the abovementioned dyes, ³O₂ must diffuse into the plastic matrix in order to reach the dye, and ¹O₂ must in turn diffuse out of the plastic matrix in order to be able to interact with the microorganisms. The same applies to the free radicals generated by the semiconductor materials; it is even necessary here not only for oxygen but additionally also for water to diffuse through the matrix. On their way through the plastic matrix, a large portion of the active antimicrobial ingredients, i.e. of the free radicals generated, will then interact/react chemically with the plastic matrix and hence become inactive in respect of the killing of the microorganisms. Furthermore, the plastic matrix is damaged thereby.

It is also known that physical methods can be used and hence active antimicrobial ingredients can be dispensed with. For example, it is known that UV radiation can be used in medicine or in hygiene, in order, for example, to disinfect water, gases or surfaces. For instance, UV radiation has long been used in drinking water treatment to reduce the number of potentially pathogenic microorganisms in the water. This is preferably done using UV-C radiation (also referred to as UVC radiation) in the wavelength range between 100 nm and 280 nm. The use of electromagnetic radiation with different wavelengths should take account of the different absorption of the different proteins, the amino acids or nucleic acids present in microorganisms, tissues or cells (for example in the DNA or RNA), and peptide bonds between the individual acids. For instance, DNA/RNA has good absorption of electromagnetic radiation in the wavelength range between 200 nm and 300 nm, and particularly good absorption between 250 nm and 280 nm, and so this radiation is particularly suitable for inactivation of DNA/RNA. It is thus possible to inactivate pathogenic microorganisms (viruses, bacteria, yeasts, moulds inter alia) with such irradiation. According to the duration and intensity of the irradiation, the structure of DNA or RNA can be destroyed. It is thus possible to inactivate metabolism-active cells and/or eliminate their reproduction capacity. What is advantageous about irradiation with UV light is that the microorganisms are unable to develop resistance thereto. However, these physical methods require specific apparatuses and generally have to be repeated regularly by trained personnel, which makes it difficult for these methods to be used widely.

Furthermore, as well as direct irradiation with electromagnetic radiation from the wavelength range of UV light, the exploitation of the effect of what is called up-conversion is also known. This uses phosphor particles with which electromagnetic radiation having wavelengths above UV light, especially visible light or infrared light, can be converted to electromagnetic radiation having shorter wavelength, such that it is possible to achieve the emission of UV-C radiation by the individual phosphor particles.

Phosphors that show up-conversion could achieve antimicrobial action by means of UV-C radiation without generating active antimicrobial ingredients. It would be possible to overcome the disadvantages indicated above that are associated with active antimicrobial ingredients using suitable phosphors.

WO 2009/064845 A2 describes, for example, a composition for converting electromagnetic energy to UV-C radiation or electromagnetic radiation of a shorter wavelength, wherein the composition comprises: at least one phosphor capable of converting an initial electromagnetic energy (A) to a different electromagnetic energy (B), wherein the different electromagnetic energy (B) comprises UV-C, x-ray or gamma radiation; and an organic or inorganic medium containing the phosphor. Organic media described include plastic resins. The concept for utilization of phosphors that have the property of up-conversion and emit UV-C radiation and hence are said to have sterilizing action is disclosed in principle in WO 2009/064845 A2. However, WO 2009/064845 A2 does not constitute an executable teaching, but is merely conceptual. More particularly, no specific example is given. In particular, however, WO 2009/064845 A2 does not disclose any phosphors according to the present invention. Of the numerous UV phosphors described in WO 2009/064845 A2, moreover, only a few are potentially capable at all of emitting UV radiation in one wavelength (UV-C radiation), such that antimicrobial action is conceivable at all. It is also not possible in principle by means of the phosphors described to achieve up-conversion such that x-ray or gamma radiation could be emitted since the up-conversion is based on electronic transitions from electrons far from the nucleus into d orbitals, whereas x-radiation is based on electronic transitions from strongly bound electrons close to the nucleus into lower-lying orbitals, and gamma radiation even arises solely in the case of spontaneous conversions (decay) of atomic nuclei, or in the event of deactivation of metastable atomic nuclei such as ^{99m}Tc.

Plastic products that show antimicrobial action without release of active antimicrobial ingredients are thus not known from the prior art.

There was therefore a need for plastic products and articles produced therefrom that do not have the disadvantages of the prior art. More particularly, they were to show antimicrobial action without requiring the release of an active antimicrobial ingredient.

It was therefore an object of the present invention to provide a plastic product and articles produced therefrom that overcome at least one drawback of the prior art. More particularly, it was an object of the present invention to provide plastic products and articles produced therefrom that show antimicrobial action without requiring the release of an active antimicrobial ingredient. Further objects that are not mentioned explicitly will become apparent from the overall context of the description, examples and claims that follow.

It has been found that, surprisingly, plastic products can have antimicrobial action even without release of an antimicrobial ingredient if they comprise specific phosphors as described in the claims.

The object of the present invention is thus achieved by the subject-matter of the independent claims. Advantageous configurations of the invention can be inferred from the subordinate claims, the examples and the description.

The present invention therefore firstly provides a plastic product comprising at least one plastic and at least one phosphor of the general formula (I)

Lu_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-e}Zr_{d}Hfₑ)ₐ₊₂ₙO₁₂ (I)
where:
a=0-1, 1≥b>0, d=0-1, e=0-1, n=0-1, z=0-1, u=0-1, v=0-1,
with the proviso that: u+v≤1 and d+e≤1,
Ln is selected from the group consisting of praseodymium (Pr), gadolinium (Gd), erbium (Er), neodymium (Nd) and yttrium (Y).

The inventive plastic products have the advantage over the prior art plastic products that their antimicrobial action is based on a purely physical principle of action and not on the release of active antimicrobial ingredients.

It is preferable here that the plastic product comprises a plastic composition which comprises the at least one plastic and the at least one phosphor.

Preference is therefore given to a plastic product which comprises or consists of a plastic composition, wherein the plastic composition comprises or consists of at least one plastic and at least one phosphor of the general formula (I)

Lu_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-e}Zr_{d}Hfₑ)ₐ₊₂ₙO₁₂ (I)
where:
a=0-1, 1≥b>0, d=0-1, e=0-1, n=0-1, z=0-1, u=0-1, v=0-1,
with the proviso that: u+v≤1 and d+e≤1,
Ln is selected from the group consisting of praseodymium (Pr), gadolinium (Gd), erbium (Er), neodymium (Nd) and yttrium (Y).

It is preferable that the phosphor has been doped with praseodymium. It is further preferable that the phosphor has been doped with praseodymium and co-doped with gadolinium.

It is preferable that the phosphor is at least partially crystalline. It is thus preferable that the phosphor is partially or fully crystalline. The phosphor is thus preferably at least not entirely amorphous. It is therefore preferable that the phosphor is not an amorphously solidified melt (glass).

The phosphor is preferably a crystalline garnet or a crystalline garnet doped with lanthanoid ions, comprising at least one alkali metal ion and/or at least one alkaline earth metal ion. The crystalline garnet here has more preferably been doped with praseodymium and optionally co-doped with gadolinium.

The phosphor has preferably been selected from compounds of the general formula (Ia)

(Lu_{1-x-y}YₓGd_{y})_{3-a-b-n}Ln_{b}(Mg_{1-z}Ca_{z)a}Liₙ(A₁₋ᵤ₋ᵥGaᵤScᵥ)₅₋ₐ₋₂ₙ(Si_{1-d-e}Zr_{d}Hfₑ)ₐ₊₂ₙO₁₂ (Ia)
where:
a=0-1, 1≥b>0, d=0-1, e=0-1, n=0-1, x=0-1, y=0-1, z=0-1, u=0-1, v=0-1,
with the proviso that: x+y≤1, u+v≤1 and d+e≤1,
Ln is selected from the group consisting of praseodymium (Pr), erbium (Er) and neodymium (Nd).

It is further preferable that the phosphor has been selected from compounds of the general formulae (Ib), (Ic), (Id) and/or (Id*):

(Lu_{1-x-y}YₓGd_{y})_{3-b}Pr_{b}(A₁₋ᵤ₋ᵥGaᵤScᵥ)₅O₁₂ (Ib)
with b=0.001-0.05, x=0-1, y=0-1, u=0-1, v=0-1,
with the proviso that: x+y≤1 and u+v≤1;

(Lu_{1-x-y}YₓGd_{y})_{3-b-a}Pr_{b}(Mg_{1-z}Ca_{z})_{a+b}Al_{5--a-b}Siₐ₊O₁₂ (Ic)
with 1≥b>0, a>0, x=0-1, y=0-1, z=0-1,
with the proviso that: x+y≤1;

(Lu_{1-x-y}YₓGd_{y})_{2-b}Pr_{b}(Ca_{1-z}Mg_{z})Al₄(Zr_{1-f}Hf_{f})O₁₂ (Id)
with b>0, x=0-1, y=0-1, z=0-1, f=0-1,
with the proviso that: x+y≤1;

(Lu_{1-x-y}YₓGd_{y})_{1-b}Pr_{b}(Ca_{1-z}Mg_{z})₂Al₃(Zr_{1-f}Hf_{f})₂O₁₂ (Id*)
with 0.5≥b>0, x=0-1, y=0-1, z=0-1, f=0-1,
with the proviso that: x+y≤1.

It is even more preferable that the phosphor has been selected from compounds of the following general formulae

(Lu_{1-x-y}YₓGd_{y})_{3-b}Pr_{b}(Al_{1-f}Ga_{f})₅O₁₂,

(Lu_{1-x-y}YₓGd_{y})_{3-b}Pr_{b}(Al_{1-f}Sc_{f})₅O₁₂,

(Lu_{1-x-y}YₓGd_{y})_{3-b}Pr_{b}(Ga_{1-f}Sc_{f})₅O₁₂,

(Lu_{1-x-y}YₓGd_{y})_{2-b}Pr_{b}CaAl₄SiO₁₂,

(Lu_{1-x-y}YₓGd_{y})_{1-b}Pr_{b}Ca₂Al₃Si₂O₁₂,

(Lu_{1-x-y}YₓGd_{y})_{2-b}Pr_{b}MgAl₄SiO₁₂,

(Lu_{1-x-y}YₓGd_{y})_{1-b}Pr_{b}Mg₂Al₃Si₂O₁₂,

(Lu_{1-x-y}YₓGd_{y})_{2-b}Pr_{b}CaAl₄(Zr_{1-f}Hf_{f})O₁₂,

(Lu_{1-x-y}YₓGd_{y})_{1-b}Pr_{b}Ca₂Al₃(Zr_{1-f}Hf_{f})₂O₁₂,

(Lu_{1-x-y}YₓGd_{y})_{2-b}Pr_{b}MgAl₄(Zr_{1-f}Hf_{f})O₁₂ or

(Lu_{1-x-y}YₓGd_{y})_{1-b}Pr_{b}Mg₂Al₃(Zr_{1-f}Hf_{f})₂O₁₂,
with b=0.001-0.05, x=0-1, y=0-1, f=0-1,
with the proviso that: x+y≤1.

The phosphor is preferably a compound of the formula Lu_{2-b}Pr_{b}LiAl₃Si₂O₁₂ with 1≥b>0, preferably with 1>b>0, more preferably with b=0.001-0.050, particularly preferably with b=0.02.

The phosphor is preferably a compound of the formula Lu₂LiAl₃Si₂O₁₂:Pr.

It should be noted here that the phosphors required for the present invention are disclosed in the patent applications EP 19202897.5 and PCT/EP2020/077796.

The phosphor is preferably a phosphor which, on irradiation with electromagnetic radiation having lower energy and longer wavelength in the range from 2000 nm to 400 nm, preferably in the range from 800 nm to 400 nm, emits electromagnetic radiation having higher energy and shorter wavelength in the range from 400 nm to 100 nm, preferably in the range from 300 nm to 200 nm. It is further preferable that the intensity of the emission maximum of the electromagnetic radiation having higher energy and shorter wavelength is at least 1·10³ counts/(mm²·s), preferably higher than 1·10⁴ counts/(mm²·s), more preferably higher than 1·10⁵ counts/(mm²·s). For determination of these indices, emission is preferably induced by means of a laser, especially a laser having a power of 75 mW at 445 nm and/or a power of 150 mW at 488 nm.

The phosphor, especially the phosphor of the formula (I), (Ia), (Ib), (Ic), (Id) or (Id*), preferably has XRPD signals from 17° 2Θ to 19° 2Θ and from 31° 2Θ to 35° 2Θ, where the signals are determined by means of the Bragg-Brentano geometry and Cu-Kα radiation. Details of the test method can be found in the patent applications EP 19202897.5 and PCT/EP2020/077796.

Patent applications EP 19202897.5 and PCT/EP2020/077796 are dedicated to the preparation of phosphors, especially of phosphors of the formulae (I), (Ia), (Ib), (Ic), (Id) and (Id*). Described therein is a process comprising the following steps:
i) providing at least one lanthanoid salt selected from lanthanoid nitrate, lanthanoid carbonate, lanthanoid carboxylate, preferably lanthanoid acetate, lanthanoid sulfate and/or lanthanoid oxide or a mixture of at least two of these, where the lanthanoid ion in the lanthanoid oxides or lanthanoid salts is selected from praseodymium, gadolinium, erbium, neodymium and, for co-doping, at least two of these are used,
ii) providing at least one element for formation of the garnet crystal lattice, selected from a lutetium source, silicon source, aluminium source or yttrium source, where the source is selected from:
   a) at least a lanthanoid salt or a lanthanoid oxide, preferably lanthanoid nitrate, lanthanoid carbonate, lanthanoid carboxylate, lanthanoid acetate, lanthanoid sulfate and/or lanthanoid oxide or a mixture of at least two of these, more preferably the lanthanoid ion is a lanthanoid oxide and/or the lanthanoid salt is a lutetium, and/or,
   b) a silicon source and/or
   c) an aluminium source, and/or
   d) yttrium salt or yttrium oxide or a mixture of these,
iii) optionally providing at least one alkaline earth metal salt and/or an alkaline earth metal oxide and/or,
iv) optionally providing at least one alkali metal salt and
v) providing a complexing agent,
   dissolving i), ii), iii), iv) and v) in acid,
   evaporating the acid and optionally the complexing agent at elevated temperature, optionally with stirring,
   obtaining a concentrated reaction product by drying the reaction product at a temperature greater than 100° C.,
   obtaining an intermediate by heating the reaction product at a temperature of up to at least 600° C. for 1 to 10 h for removal of organic compounds,
   heating the intermediate up to at least 1200° C., for 0.5 to 10 h,
   cooling and
   obtaining a lanthanoid ion-doped garnet.

Further detailed embodiments of the process can be found in EP 19202897.5 and PCT/EP2020/077796.

It has been found that, surprisingly, the phosphors according to EP 19202897.5 and PCT/EP2020/077796 have the required up-conversion property responsible for antimicrobial action. These phosphors can thus convert electromagnetic radiation having wavelengths above UV light, especially visible light or infrared light, to electromagnetic radiation having a shorter wavelength, specifically in the region in which, for example, the DNA or RNA of the microorganisms can be destroyed. Accordingly, these phosphors are of very good suitability for the plastic product according to the invention.

It is preferable that the production of the phosphor does not exceed a temperature of 1800° C., preferably of 1700° C., particularly of 1600° C.

It is preferable that the phosphor has a particle size d50 of 0.1 to 100 μm, preferably of 0.1 to 10 μm, especially of 0.1 to 5 μm. Particle size is preferably measured to ISO 13320:2020 and/or USP 429, for example with a Horiba LA-950 Laser Particle Size Analyzer.

In order to efficiently incorporate and/or to stabilize the phosphors in the plastic product of the invention, it is preferably possible to add various additives.

It is further preferable for the proportion by mass of the total amount of all phosphors to be from 0.02% to <50.00%, preferably from 0.05% to 10.00%, especially from 1.00% to 7.00%, based on the total mass of the plastic product.

It is further preferable that the phosphor has been embedded in the plastic. It is thus preferable that the phosphor has been partially or completely embedded in the plastic. It is thus preferable that the plastic forms a matrix for the phosphor. It is especially preferable that the phosphor is dispersed in the plastic. It is thus especially preferable that the phosphor is partially or completely dispersed in the plastic. The phosphor is thus preferably dispersed in the plastic in the form of a particulate solid. The phosphor is thus preferably partially or completely dispersed in the plastic in the form of a particulate solid.

The plastic product according to the invention, as well as the at least one phosphor, also contains at least one plastic. In principle, all plastics known from the prior art are useful, provided that they are sufficiently transparent to the light in the spectral ranges that are important for the excitation and emission. Suitable plastics and methods of selection thereof are known to the person skilled in the art.

It is preferable for the at least one plastic to be selected from the group consisting of thermoplastics and thermosets, preferably from thermoplastics.

“Thermoplastics” refers here to those polymers which have a flow transition range above the use temperature. Thermoplastics are linear or branched polymers which in principle become free-flowing above the glass transition temperature (Tg) in the case of amorphous thermoplastics and above the melting temperature (Tm) in the case of (semi)crystalline thermoplastics. In the softened state they can be processed into mouldings by compression, extrusion, injection moulding, or other shaping processes. Chain mobility becomes so great here that the polymer molecules slide easily against one another and the material reaches the molten state (flow range, polymer melt). The thermoplastics furthermore also include thermoplastically processible plastics with pronounced entropy-elastic properties known as thermoplastic elastomers. The thermoplastics include all plastics composed of polymer molecules that are linear or that have been crosslinked in a thermally labile manner, examples being polyolefins, vinyl polymers, polyesters, polyacetals, polyacetates, polycarbonates, and also some polyurethanes and ionomers, and also TPEs—thermoplastic elastomers (RÖMPP ONLINE, vers, 4.0, Carlowitz and Wierer, Kunststoffe (Merkblätter) [Plastics (Datasheets)], Chapter 1, Thermoplaste [Thermoplastics], Berlin: Springer Verlag (1987), Domininghaus, p. 95 ff.).

If a thermoplastic is selected as plastic, it is preferable for the thermoplastic to be selected from the group consisting of acrylonitrile-butadiene-styrene (ABS), polyamide (PA), polylactate (PLA), poly(alkyl)(meth)acrylate, polymethylmethacrylate (PMMA), polycarbonate (PC), polyethylene terephthalate (PET), polyethylene (PE), polypropylene (PP), polystyrene (PS), polyether ether ketone (PEEK), polyvinyl chloride (PVC), cycloolefin polymers (COP), cycloolefin copolymers (COC), and thermoplastic elastomers (TPE), wherein the thermoplastic elastomers are preferably selected from the group consisting of thermoplastic polyamide elastomers (TPA, TPE-A), thermoplastic copolyester elastomers (TPC, TPE-E), thermoplastic elastomers based on olefins (TPO, TPE-O), thermoplastic styrene block copolymers (TPS, TPES), thermoplastic polyurethanes (TPU), thermoplastic vulcanizates (TPV, TPE-V) and crosslinked thermoplastic elastomers based on olefins (TPV, TPE-V).

The expression “(meth)acryl” here represents “methacryl” and/or “acryl” and the expression “poly(alkyl)(meth)acrylate” represents a homopolymer or copolymer of alkyl (meth)acrylates and optionally further monomers.

In a likewise preferred embodiment, the plastic is selected from the group consisting of thermosets.

Thermosets are plastics which are formed from oligomers (technically: prepolymers), less commonly from monomers or polymers, by irreversible and dense crosslinking via covalent bonds. The word “thermoset” is used here both for the raw materials prior to crosslinking (see reactive resins) and as a collective term for the cured, mostly completely amorphous resins. Thermosets are energy-elastic at low temperatures, and even at higher temperatures they are not capable of viscous flow, but instead exhibit elastic behaviour with very restricted deformability. The thermosets include the industrially important substance groups of the diallyl phthalate resins (DAP), epoxy resins (EP), urea-formaldehyde resins (UF), melamine-formaldehyde resins (MF), melamine-phenol-formaldehyde resins (MPF), phenol-formaldehyde resins (PF), vinyl ester resins (VE) and unsaturated polyester resins (UP, UPES) (RÖMPP ONLINE, vers. 3.7, Becker, G. W.; Braun, D.; Woebcken, W., Kunststoff-Handbuch [Plastics Handbook], vol. 10: Duroplaste [Thermosets], 2nd Edn.; Hanser Munich, (1988); Elias (6th) 1, 7, 476 ff.) If a thermoset is selected as plastic, it is preferable for the thermoset to be selected from the group consisting of diallyl phthalate resins (DAP), epoxy resins (EP), urea-formaldehyde resins (UF), melamine-formaldehyde resins (MF), melamine-phenol-formaldehyde resins (MPF), phenol-formaldehyde resins (PF), unsaturated polyester resins (UP, UPES), vinyl ester resins (VE) and polyurethanes (PU).

The plastic is preferably essentially free or entirely free of aromatic groups, C—C double bonds and C-C triple bonds, the latter being applicable to the state of the plastic after curing, i.e. to the state of the plastic as preferably present as a constituent of the plastic product.

The person skilled in the art is aware of the physical interactions of light with a material and the material surface thereof. According to the material and its material surface, a multitude of effects occur on incidence of light. The incident light is partly absorbed, partly reflected and may also be scattered. Light can also first be absorbed and then emitted again. In the case of opaque, semitransparent or transparent materials, the light can also penetrate through the body (transmittance). The material may be transparent or translucent. In some cases, the light is even polarized or diffracted at the surface. Some objects can even emit light (illuminated displays, LED segments, displays), or fluoresce or phosphoresce in light of a different colour (afterglow).

The plastic preferably has low resonance. What is meant by “low resonance” in the context of this invention is that the plastic has low absorption, reflection, reflectance and scatter. By contrast, transmittance should preferably be pronounced.

Low-resonance plastics show improved antimicrobial action because more electromagnetic radiation having lower energy and longer wavelength in the range from 2000 nm to 400 nm, especially in the range from 800 nm to 400 nm, is transmitted by the plastic and, as a result, more electromagnetic radiation having higher energy and shorter wavelength in the range from 400 nm to 100 nm, preferably in the range from 300 nm to 200 nm, can be emitted in turn.

The transmittance of the plastic is preferably at least 60%, more preferably at least 65% and especially preferably at least 70%, measured at a wavelength of 260 nm and a material thickness of preferably 100 μm.

The transmittance of the plastic is preferably at least 60%, more preferably at least 65% and especially preferably at least 70%, measured at a wavelength of 500 nm and a material thickness of preferably 100 μm.

It should be noted that a transmittance as specified above constitutes a sufficient but not absolute criterion for the suitability of the plastic. For example, suitable plastics may also be those that have low transmittance if they merely scatter the light. This may be the case for semicrystalline or crystalline plastics. Therefore, a factor of relevance for display of antimicrobial action is instead that the radiation is not absorbed by the plastic.

For the present invention, the wavelengths of 260 nm by way of example for the wavelength emitted and 500 nm by way of example for the excitation wavelength were chosen, which are responsible firstly for the up-conversion and secondly to a significant degree for the antimicrobial action.

Transmittance is preferably determined as described in the examples. Transmittance is thus preferably measured with a “Specord 200 Plus” twin-beam UV/VIS spectrometer from Analytik Jena. A holmium oxide filter is used for internal wavelength calibration. Monochromatic light from a deuterium lamp (UV range) or a tungsten-halogen lamp (visible range) is passed through the samples. The spectral range is 1.4 nm. The monochromatic light is divided into a measurement channel and a reference channel and enables direct measuring against a reference sample. The radiation transmitted through the sample is detected by a photodiode and processed. The material thickness (layer thickness) of the sample is preferably 100 μm.

The plastics are preferably selected such that the plastic product according to the invention has high chemical and mechanical stability. Chemical and mechanical stability is particularly important since antimicrobial plastic products are frequently used in areas that require regular disinfection and further hygiene measures.

It is preferable for the proportion by mass of the total amount of all plastics to be from >50.00% to 99.98%, preferably from 90.00% to 99.95%, especially from 93.00% to 99.00%, based on the total mass of the plastic product according to the invention.

It is preferable for the plastic product to contain further additions selected from the group consisting of colourants, for example pigments or dyes, light and UV stabilizers, for example hindered amine light stabilizers (HALS), heat stabilizers, UV absorbers, excluding materials that absorb UV-C, IR absorbers, inorganic or organic flame retardants, thermal stabilizers, antioxidants, crosslinking additives and polymers, fibre-reinforcing additives with an organic or inorganic basis, such as for example cellulose fibres, flax fibres, bamboo fibres, glass fibres or carbon fibres, antistatic additives, impact modifiers, odour absorbers, additives and polymers for improved barrier properties, inorganic and organic fillers, and auxiliaries. These additives are known to those skilled in the art. It is preferable that the plastic product does not contain any active antimicrobial ingredients. In selection of the additions, it should of course be ensured that they do not impair the antimicrobial action of the phosphors. For example, in the selection of the colourants and UV absorbers and in the selection of the amount to be used, it should be ensured that the radiation required for the excitation of the phosphors and the UV-C radiation emitted by the phosphors is not absorbed to such a degree that antimicrobial action is prevented.

The plastics compositions according to the invention preferably contain the abovementioned further additions in a proportion by mass of at most 10%, preferably at most 5% and especially at most 2%.

The plastic product according to the invention preferably has antimicrobial action against bacteria, yeasts, fungi, algae, parasites and/or viruses.

“Antimicrobial action” of a plastic product is understood to mean that the plastic product limits or prevents the growth and/or reproduction of microorganisms. Without being limited thereto, microorganisms here include unicellular or multicellular, DNA- or RNA-based, prokaryotic or eukaryotic microorganisms, and infectious organic structures capable of reproduction (viruses, virions and virusoids, viroids), with active or inactive (resting) metabolism or else without metabolism. The antimicrobial action may be chemical (material-based) or physical (radiation, heat, mechanical effects) in nature.

The plastic product according to the invention preferably has antimicrobial action against
pathogens of nosocomial infections, preferably against Enterococcus faecium, Staphylococcus aureus, Klebsiella pneumoniae, Acinetobacter baumannii, Pseudomonas aeruginosa, Escherichia coli, Enterobacter, Corynebacterium diphteria, Candida albicans, rotaviruses, bacteriophages;
facultatively pathogenic environmental organisms, preferably against Cryptosporidium parvum, Giardia lamblia, amoebas (Arcanthamoeba spp., Naegleria spp.), E. coli, coliform bacteria, faecal streptococci, Salmonella spp., Shigella spp., Legionella spec., Pseudomonas aeruginosa, Mykobakteria spp., enteral viruses (e.g. polio and hepatitis A virus);
pathogens in food and drink, preferably against Bacillus cereus, Campylobacter spp., Clostridium botulinum, Clostridium perfringens, Cronobacter spp., E. coli, Listeria monocytogenes, Salmonella spp., Staphylococcus aureus, Vibrio spp., Yersinia enterocolitica, bacteriophages.

It is further preferable that the plastic product is solid at a temperature of 25° C. and a pressure of p=1.01325 bar.

It is preferable that the plastic product is selected from the group consisting of moulding compounds, shaped bodies, mouldings, workpieces, semifinished products, finished products, granules, masterbatches, fibres and films, preferably from the group consisting of shaped bodies, mouldings, workpieces, semifinished products, finished products, fibres and films, especially from films.

It is preferable that the plastic product is not a coating and does not have one, preferably any coating having a layer thickness of less than 40 μm, especially any coating having a layer thickness of less than 31 μm, i.e., for example, any coating having a layer thickness of 30 μm. A coating in the context of the present invention is understood to mean a layer which is obtained by applying a liquid coating composition to a solid surface, followed by curing of the liquid composition, i.e. of the liquid coating composition (by drying, solidification or chemical reaction). A coating in the context of the present invention is explicitly not understood to mean a layer that has been produced by means of coextrusion, for example a layer (e.g. an inner layer or an outer layer (cover layer)) of a multilayer film produced by means of coextrusion.

If the plastic product of the invention is selected from the group consisting of shaped bodies, mouldings, workpieces, semifinished products, finished products, fibres and films, especially from films, the plastic product is preferably produced from a moulding compound, a granular material and/or a masterbatch. It is preferable in that case that the moulding compound, granular material and/or masterbatch comprises or consists of the plastic to be used in accordance with the invention and the phosphor to be used in accordance with the invention.

The plastic product according to the invention may be obtained via numerous manufacturing methods as described with preference in standard DIN 8580:2003-09.

It is preferable that the plastic products of the invention, such as semifinished products and/or finished products, are preferably produced by primary forming and/or shaping methods.

Preference is given here to primary forming processes selected from the group consisting of primary forming from the liquid state and primary forming from the plastic state; preferably selected from the group consisting of gravity casting, die casting, low-pressure casting, centrifugal casting, dip moulding, primary forming of fibre-reinforced plastics, compression moulding, injection moulding, transfer moulding, extrusion moulding, extrusion, drape forming, calendering, blow moulding and modelling. These primary forming processes are described for example in standard DIN 8580:2003-09.

Preference is also given here to shaping processes selected from the group consisting of deep drawing, thermoforming and rolling. Suitable shaping processes are described for example in standard DIN 8580:2003-09.

It is particularly preferable that the plastic products according to the invention are produced by means of extrusion, calendering and/or rolling, most preferably by means of extrusion.

It is further preferable that the plastic products according to the invention are produced by means of 3D printing, preferably in a melt layering method, including that of a fused deposition modeling (FDM) or fused filament fabrication (FFF).

Plastic products in which the plastics are selected from thermoplastics can be produced in various mixing units such as for example twin-screw extruders, BUSS kneaders, on a roll and in other units known to those skilled in the art by melting the thermoplastic and adding the phosphor and can subsequently be used directly or in a separate process for producing a shaped body or component. Nonlimiting examples of such processes may be: injection moulding, extrusion of profiles, sheets, films, and also thermoforming processes.

The resulting component is frequently also referred to as a shaped body, with the term component or shaped body not being limited to thermoplastic products. The invention further provides multipart components produced from the additional use of the plastic products according to the invention, for example co-extruded or laminated multilayer sheets or films or components in multicomponent injection moulding.

One advantage of the plastic product according to the invention is that, when new surfaces are created (for example by forming, drilling, sawing, grinding, material-removing processing), these are immediately endowed with the antimicrobial properties since the phosphor particles are preferably distributed uniformly in the plastic product. However, it is also possible, for example, to conduct coextrusion of a thin layer provided with the particles for generation of antimicrobial surfaces with saving of costs; in this case, the plastic product would then possibly not be entirely antimicrobial (i.e. not antimicrobial throughout its volume), but merely part of the surface. In this case, the extruded material would behave like an antimicrobial coating. It should be pointed out that, in the context of the present invention, the antimicrobial layer of a coextrusion material is not regarded as a coating. The antimicrobial layer of a coextruded material is the result of a thermoplastic processing operation. By contrast, a coating is the result of a processing operation in which a liquid is applied to solid surfaces, and this liquid cures at a later stage.

The plastic product according to the invention may be used for production of articles having antimicrobial action.

An article having antimicrobial action here is an article which, over at least part of its surface, limits or prevents the growth and/or reproduction of microorganisms.

The invention thus further provides an article that comprises and/or is produced from the plastic product according to the invention.

This article, as well as the plastic product, may have further parts (e.g. constituent parts) and components that differ from the plastic product according to the invention. Such parts and components may be made, for example, of metal or wood; it may alternatively be a plastic product without phosphor.

The plastic product according to the invention or the article according to the invention that comprises and/or has been produced from the plastic product are preferably used in hygiene facilities, hospitals, and/or in the foods industry.

They may alternatively be used in other sectors of the public sphere, for example in nurseries, schools, care facilities, old people's homes, large-scale kitchens and/or swimming baths.

The plastic product according to the invention or the article according to the invention may also be a domestic article/domestic appliance or part of a domestic article/domestic appliance, for example a component or operating element (e.g. rotary controls, switches, fittings etc.). Examples of customary domestic article/domestic appliances are coffee machines, stoves, washing machines, machine dishwashers and vessels (for example for detergents, fabric softeners, cleaning products, foods, spices, pharmaceuticals, hair products and cosmetics).

The plastic products according to the invention or the articles that comprise and/or are produced from these plastic products are preferably selected from:
kitchen and laboratory worktops,
films, fibres, profile strips, decorative strips and cables.
medical products and medical devices, especially catheters and vessels for collecting and/or storing body fluids such as blood and blood constituents,
articles for hygiene facilities, hospitals and/or the foods industry,
decorative covering panels, installable components, interior components or exterior components in motor vehicles (for example in hire cars and car-sharing vehicles), in boats, in trains and/or in aircraft,
consumer electronics,
domestic articles/domestic appliances,
toys,
sports equipment,
articles in leisure facilities such as saunas, baths, spas and/or wellness centres,
furniture,
articles in modes of public transport,
packaging, especially also in the foods sector,
surfaces (e.g. plastic surfaces or textile surfaces) of the abovementioned objects.
or components and operating elements for the aforementioned objects.

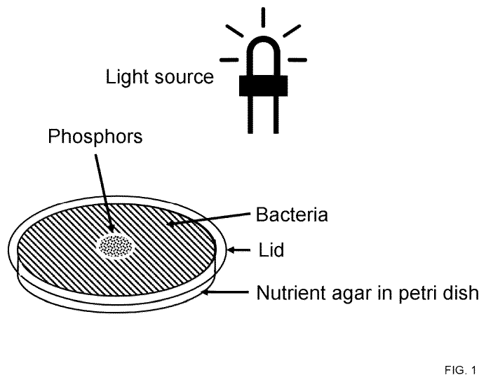

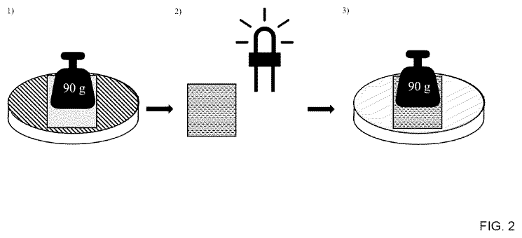

The subject-matter of the present invention is more particularly elucidated with reference to FIG. 1 and FIG. 2, without any intention that the subject-matter of the present invention be restricted thereto.

### DESCRIPTION OF THE FIGURES

FIG. 1: Construction of the agar plate test.
The phosphor sample ( [symbol] ) is applied to a confluent inoculated nutrient agar plate ( [symbol] ) and incubated at room temperature under constant illumination for 24±1 h To verify the antimicrobial efficacy through the effect of the up-conversion, the samples were additionally incubated in the dark.

FIG. 2: Construction of the transfer method.
The plastic products with the phosphors present are pressed onto a confluently inoculated nutrient agar plate with a defined weight (1). The bacteria transferred thereby are incubated at room temperature under the illumination or in the dark (2). The antimicrobial effect is detected by means of contact with nutrient agar under defined weight (3).

Examples are cited hereinafter that serve solely to elucidate the execution of this invention to the person skilled in the art. They in no way whatsoever represent a restriction of the claimed subject-matter.

### EXAMPLES

### 1 Methods and Materials

### 1.1 Measurement of Transmittance

The measurements of transmittance were determined with a “Specord 200 Plus” twin-beam UV/VIS spectrometer from Analytik Jena. A holmium oxide filter is used for internal wavelength calibration. Monochromatic light from a deuterium lamp (UV range) or a tungsten-halogen lamp (visible range) was passed through the samples. The spectral range is 1.4 nm. The monochromatic light is divided into a measurement channel and a reference channel and enables direct measuring against a reference sample. The radiation transmitted through the sample is detected by a photodiode and processed. The measurements were effected in transmission mode. The measurement range was 190 to 1100 nm with a step width of 1 nm. The measurement speed was 10 nm/s, corresponding to an integration time of 0.1 s.

### 1.2 Equipment

Speedmixer, from Hauschild Engineering Modell FAC 150.1 FVZ for the production of the UPES and UP samples
Laboratory balance. Sartorius MSE 6202 S 100 DO
Haemocytometer (Thoma counting chamber), from Brandt
Agitated waterbath: GFL 1083, from Byk Gardner
Specord 200 Plus twin-beam UV/VIS spectrometer, from Analytik Jena
Extruder for the production of the compounds in the form of Leistritz ZSE27MX-44D twin-screw extruder, from Leistritz Extrusionstechnik GmbH
System for production of blown films or cast films in the form of Brabender Lab Station of model 815801 from Brabender GmbH & Co KG with Brabender Univex Take off cast film unit of model 843322 and Brabender blown film unit of model 840806.
Injection moulding machine for the production of sheets/shaped bodies, model: ES 200/50HL, from Engel Schwertberg, Austria, containing injection moulds from AXXICON, Germany

### 1.3 Culture Media

Caso broth: from Merck KGaA Millipore
CASO nutrient agar plates: from Oxoid

### 1.4 Materials for Production of the Plastic Products and Processing Parameters Thereof

Materials, raw materials and plastics for production of the plastic products can be found in Table 1. Processing parameters are reported for thermoplastics (PE, PP), whereas only the ingredients are listed for thermosets (UPES), and the processing is described specifically in connection with the production of the samples.

TABLE 1
Materials, raw materials or plastics for production of the plastic products

| | | Extrusion | | |
|---|---|---|---|---|
| | | temperature | Speed | Pressure |
| Material/raw material/plastic | | [° C.] | [rpm] | [bar] |
| PE | Borealis CA 7230 | 185 | 200 | 60 |
| | (Borealis) | | | |
| PP | Polypropylene | 205 | 200 | 40 |
| | Borealis BE 170 CF | | | |
| | (Borealis) | | | |
| UPES | DISTITRON ® 416 B1 | — | — | — |
| | V12 (Polynt) | | | |
| Catalyst | Butanox LPT-IN | — | — | — |
| Accelerator | Accelerator NL-49P | — | — | — |

### 1.5 Selection of the Plastics by Means of Transmittance Measurement

UV/VIS transmission spectra were conducted for some plastics. The production of the samples is described in 2.3.1. A sufficient criterion (but not an absolute criterion) for the suitability of a plastic is that transmittance is at least 60% at a wavelength of 260 nm and 500 nm at a material thickness of 100 μm.

TABLE 2
Overview of transmittance at 260 nm and 500 nm at a material
thickness of 100 μm

| | Transmittance at | Transmittance at |
|---|---|---|
| Plastic | 260 nm [%] | 500 nm [%] |
| PE | 72.52 | 85.101 |
| UPES | 65.31 | 78.29 |
| PP | 74.02 | 83.01 |

### 2 Testing of Antimicrobial Efficacy

### 2.1 Selection of Phosphors

The following phosphors were used:
Lu₂LiAl₃Si₂O₁₂:Pr, prepared according to Example 5 of patent applications EP 19202897.5 and PCT/EP2020/077796, i.e. according to the following method:
“Example 5: (Lu_{0.99}Pr_{0.01})₂LiAl₃Si₂O₁₂
3.1516 g (7.9200 mmol) Lu₂O₃, 0.0272 g (0.0267 mmol) Pr₆O₁₁, 9.0032 g (24.0000 mmol) Al(NO₃)₃·9H₂O, 0.2956 g (4.0000 mmol) Li₂CO₃, 3.3333 g (16.0000 mmol) Si(OC₂H₅)₄ and 40.3470 g (192.0000 mmol) citric acid were dissolved in dilute nitric acid. The solution was stirred vigorously at 65° C. to obtain a sol. The sol was dried at 150° C. overnight to turn it into a gel. Subsequent calcination at 1000° C. in a muffle furnace for four hours in air removed organic residues. A further calcination step at 1600° C. for one hour in air was performed to obtain the product phase.”
Li₄P₂O₇, prepared by the following method:
1.8473 g (25.0000 mmol) of Li₂O₃ and 2.8756 g (25.000 mmol) of NH₄H₂PO₄ were mixed in acetone in an agate mortar. This prepared mixture was calcined under normal (air) atmosphere at 500° C. for 6 h. Calcination was effected under normal (air) atmosphere at 650° C. for a further 12 h to obtain the product.
BaY₂Si₃O₁₀:Pr³⁺, prepared by the following method:
2.1273 g (10.7800 mmol) of BaCO₃, 1.9828 g (33.0000 mmol) of SiO₂. 2.4839 g (11.0000 mmol) and 0.0187 g (0.0183 mmol) of Pr₆O₁₁ were mixed in acetone in an agate mortar. This prepared mixture was calcined under a CO atmosphere at 1400° C. for 6 h to obtain the product.
Ca₃Sc₂Si₃O₁₂:Pr³⁺, Na⁺(1%), prepared by the following method: 1.8119 g (18.1030 mmol) of CaCO₃, 0.0104 g (0.0102 mmol) of Pr₆O₁₁, 0.8428 g (6.1110 mmol) of Sc₂O₃ and 0.0032 g (0.0306 mmol) of Na₂CO₃ were dissolved in hot concentrated nitric acid. The solution was concentrated in order to obtain the nitrates. Water was added to the nitrates while stirring constantly. 1.1043 g (18.3790 mmol) of SiO₂ was mixed with 20 ml of water and placed in an ultrasound bath to separate the agglomerates. This dispersion was fed into the abovementioned water/nitrate solution and mixed. 11.1314 g (121.1300 mmol) of C₄H₁₁NO₃ was added thereto. The solution was concentrated. The reaction product was dried at 150° C. Then the reaction product was calcined under normal (air) atmosphere in a muffle furnace at 1000° C. for 2 h. A further calcination step was conducted at 1300° C. under a forming gas (N₂/H₂; 95%/5%) for 4 h to obtain the product.

### 2.2 Testing of the Antimicrobial Efficacy of the Phosphors

First of all, the antimicrobial efficacy of phosphors as such was tested. The efficacy of the phosphors was tested against Gram-positive and Gram-negative test organisms.

Testing was effected on Bacillus subtilis, which is used for biodosimetric testing of UV systems in DVGW (German Technical and Scientific Association for Gas and Water) Arbeitsblatt W 294 “UV-Geräte zur Desinfektion in der Wasserversorgung” [Standard W 294 “UV Instruments for Disinfection in Water Supply” ]. Being a Gram-positive spore-forming bacterium, it is particularly insensitive to UV radiation and hence of good suitability as a worst case for testing of the antimicrobial action of UV radiation.

In addition, antimicrobial efficacy was tested on Escherichia coli, in order to show antimicrobial action against Gram-negative bacteria. E. coli is a Gram-negative aerobic bacterium that occurs predominantly in the human intestinal tract and is thus a typical indicator of faecal contamination. In the event of contamination of other tissues with E. coli, the result is frequently infection diseases, for example infections in the urogenital tract.

### 2.2.1 Agar Plate Test

Using the agar plate test, the antimicrobial action of phosphors on the test organisms B. subtilis and E. coli was verified.

For testing, solid nutrient agar plates were confluently inoculated with a bacteria suspension of the test organisms. The phosphor samples were applied to the inoculated nutrient plates (FIG. 1). The plates were incubated under suitable growth conditions. After the plates had been incubated, the growth-inhibiting properties were assessed from the formation of a zone without colony growth concentrically at and around the accumulation of phosphors on the nutrient plates.

The test organisms used were Bacillus subtilis subsp. spizizenii (DSM 347, ATCC 6633) and Escherichia coli (DSM 1116; ATCC 9637). The test organisms were used in suspension with a final concentration of 10⁷ cells/ml.

The bacteria suspensions were produced by dilutions of pre-cultures of the respective bacterial strain. Dilution was effected in sterile deionized water. The pre-cultures of the test organisms were produced in sterilized casein peptone-soya flour peptone (CASO) broth. The pre-culture of B. subtilis was incubated at 30° C. with constant agitation in an agitated waterbath for 16 t 1 h. The pre-culture of E. coli was incubated at 36° C. in a thermally insulated Erlenmeyer flask with a magnetic stirrer bar with constant stirring at 350 rpm. The cell titre of the pre-cultures was determined by microscopy with a haemocytometer (Thoma counting chamber).

For the agar plate test, 1.0 ml of the bacteria suspension with 10⁷ cells/mi was distributed homogeneously over a sterile CASO agar plate in order to assure confluent coverage of the nutrient agar. The bacteria suspension applied was equilibrated on the nutrient agar at room temperature (22±2° C.) for 300±30 sec before the phosphors were applied centrally. In addition, calcium carbonate and copper oxide were each also applied centrally to the nutrient plates as negative and positive reference. It is known that copper oxides have a growth-inhibiting effect, whereas calcium carbonates must not show any growth-inhibiting effect.

The nutrient plates were incubated under constant illumination at room temperature for 24±1 h. The same preparation was additionally also incubated in the dark.

Incubating under illumination and in the dark, if there is any growth-inhibiting effect in the illuminated state only, should indicate up-conversion of the phosphors.

All samples and references were tested in triplicate and with and without illumination over the incubation period of 24±1 h.

The terms “phosphors” and “phosphor particles” are used as synonyms.

### 2.2.2 Results of the Agar Plate Tests

The growth-inhibiting effect of the phosphors on bacteria was detected visually after 24±1 h at room temperature (Table 3).

There is a growth-inhibiting effect when a concentric zone without bacterial colony growth arises around and at the accumulated phosphor particles or reference particles on the nutrient agar.

There is no growth-inhibiting effect when bacterial colony growth is detected on the nutrient agar around and at the accumulated phosphor particles or reference particles.

After incubation under illumination after 24±1 h at room temperature, it was possible to detect a growth-inhibiting effect of the phosphor Lu₂LiAl₃Si₂O₁₂:Pr for B. subtilis and E. coli. It was not possible to detect any growth-inhibiting effect around the other phosphors (Table 3).

For all phosphors, it was not possible to detect any bacterial colony growth on the darkened incubation conditions around and at the accumulated phosphor particles.

The results show clearly that the reason for the antimicrobial action of the phosphors Lu₂LiAl₃Si₂O₁₂:Pr is the physical effect of the UV emission in the light-excited state. In the darkened state, no up-conversion takes place, and so no antimicrobial action of the phosphors was detectable in the darkened state.

The reference with calcium carbonate did not show any zone with inhibition of bacterial growth either under light or dark conditions. By contrast, the reference with copper oxide shows a concentric zone without bacterial colony growth both under light and dark conditions.

The phosphors additionally did not show any genuine bacterial contamination.

The results show that the phosphor Lu₂LiAl₃Si₂O₁₂:Pr is suitable for the plastic product according to the invention. This phosphor is also referred to hereinafter as phosphor according to the invention.

TABLE 3
Results of the agar plate test

| | Growth-inhibiting | | Growth-inhibiting | |
|---|---|---|---|---|
| | effect on B. subtilis | | effect on E. coli | |
| Phosphor | Illuminated | Darkened | Illuminated | Darkened |
| Lu₂LiAl₃Si₂O₁₂: Pr | Yes | No | Yes | No |
| Li₄P₂O₇ | No | No | No | No |
| BaY₂Si₃O₁₀: Pr³⁺ | No | No | No | No |
| Ca₃Sc₂Si₃O₁₂: Pr³⁺, Na⁺ | No | No | No | No |
| Calcium carbonate reference | Nc | No | No | Nc |
| Copper oxide reference | Yes | Yes | Yes | Yes |

### 2.3 Testing of the Antimicrobial Efficacy of a Plastic Product According to the Invention

It was shown under 2.2 that the phosphor Lu₂LiAl₃Si₂O₁₂:Pr as such has an antimicrobial effect. It will be shown hereinafter that this antimicrobial effect is also observed in the plastic product according to the invention.

It should be noted here that the terms “antimicrobial action”, “antimicrobial effect”, “antimicrobial efficacy” and “antimicrobial property” are used as synonyms.

The antimicrobial efficacy of the plastic product according to the invention is tested by incorporating the phosphor Lu₂LiAl₃Si₂O₁₂:Pr into plastics.

### 2.3.1 Production of a Plastic Product

The application methods applied which were used to produce the inventive and non-inventive plastic products are detailed hereafter.

### 2.3.1.1 Production of a Thermoplastic Compound for Production of the Mixtures for the Thermoplastic Test Specimens

Premixes of 2.5 kg each, consisting of the appropriate plastic (PE, PP) and the phosphor, were made up. The phosphor was added in the respectively reported proportions by mass, based on the total composition of the premix (reported in % or, with the same meaning, % by weight). A comparative mixture without phosphor was considered in each case. Mixtures with 1% and with 5% phosphor were produced.

The resulting premix was subsequently introduced into a Brabender metering unit and fed via a conveying screw to the Leistritz ZSE27MX-44D twin-screw extruder (manufacturer Leistritz Extrusionstechnik GmbH) for the processing. The processing to give the respective compound was effected at a defined speed (rpm) and a defined temperature setting. The plastic strand was then pelletized using a 3.20 m waterbath for strand cooling. The temperature profiles of the respective plastics were selected in accordance with the technical data sheets. The temperatures, speeds and pressures of the various plastics can be found in Table 1.

In the premixes, the plastics are used in powder form if possible (for example through prior grinding), in order that the phosphor can be efficiently mixed in.

### 2.3.1.2 Production of Plastic Products in the Form of PE-Based Blown Films or PP-Based Blown or Cast Films

A Brabender Lab Station type 815801 from Brabender GmbH & Co KG was used to produce the films and the material was fed to the die using the associated mini extruder from Brabender, type: 625249,120. Either a 15 cm wide slot die for cast films was fitted or a blown film head having a diameter of 10 cm was used. The cast films were then wound up on a Brabender Univex Take off apparatus type: 843322 and the blown films on a Brabender apparatus type: 840806. The conditions for film production were taken from the technical data sheets for the plastics processed and all films were produced at a speed of 18 m/min. For the performance of the transfer method (see 2.3.2), the films obtained were cut to a size of 2.5 cm×4 cm. This method was used to process the plastic products to films that were produced beforehand as compounds with and without phosphor according to 2.3.1.1.

### 2.3.1.3 Production of Plastic Products Based on UPES

For the production of the UPES-based plastic product, the aforementioned Speedmixer was used, and the components listed in Table 4 including the phosphor were incorporated successively as follows. The main component of the plastic product, i.e. UPES (see Table 1), is introduced into the Speedmixer pot, and the catalyst (0.98% by weight based on the total mass of the mixture) is mixed in at 2500 rpm for 15 s. Subsequently, the accelerator (0.29% by weight based on the total mass of the mixture) was likewise mixed in at 2500 rpm for 15 s. If a phosphor was added to the formulation, the phosphor according to the invention (0% by weight, 1% by weight or 5% by weight based on the total mass of the mixture) was added directly to the UPES prior to addition of the catalyst and accelerator, and this mixture was then mixed at 2500 rpm for 60 s. Only then were the catalyst and accelerator added.

In the next step, the mixtures were poured out into aluminium dishes having a diameter of 10 cm. These aluminium dishes were preheated beforehand on a hotplate at 50° C. for 5 min, and remain on this hotplate during the filling and for a further 2 min thereafter. Subsequently, the filled aluminium dishes are stored at room temperature for 24 h and then placed into an oven at 80° C. for 5 h. The resultant plastic products were taken from the oven and placed in a fume hood at room temperature for a further 24 hours. Only then was the antimicrobial action of the resulting plastic products with or without phosphor tested.

### 2.3.1.4 Production of Shaped PP Bodies (Sheets)

The compounds produced were processed on an injection moulding machine (type: ES 200/50HL, from Engel Schwertberg, Austria) into smooth sheets (injection mould: double sheets smooth, from AXXICON) having a size of 6 cm×6 cm and a thickness of 2 mm. The injection moulding conditions were taken from the technical data sheet for the PP. PP-based plastic products containing 1% and 5% phosphor were compared to one without phosphor, which were manufactured as compounds according to 2.3.1.1.

### 2.3.2 Procedure for the Transfer Method

The test organism used was again Bacillus subtilis subsp. spizizenii (DSM 347. ATCC 6633). 1 ml of a B. subtilis suspension with a final concentration of 10⁷ cells/ml was distributed homogeneously over a sterile CASO agar plate in order to assure confluent coverage of the nutrient agar. The bacteria suspension applied was equilibrated on the nutrient agar at room temperature (22±2° C.) for 300±30 sec. The bacteria suspensions was produced by dilutions of pre-cultures of the respective bacterial strain. Dilution was effected in sterile deionized water. The pre-cultures of the test organisms were produced in CASO broth. The pre-culture of B. subtilis was incubated at 30° C. with constant agitation in an agitated waterbath for 16±1 h. The cell titre of the pre-cultures was determined by microscopy with a haemocytometer (Thoma counting chamber).

The aim of the transfer method is to simulate the antimicrobial action of the plastic surface under near-reality conditions on a dry inanimate surface. For this purpose, plastic products obtained as described above were pressed onto a nutrient agar plate confluently inoculated with B. subtilis with a defined weight of 90±1 g for 60±5 s. This step transferred the bacteria in semi-dry form to the surface of the plastic products. Subsequently, the plastic products were placed into an empty petri dish with the coated and inoculated side upward and incubated under illumination at room temperature for 0 h, 1 h, 2 h, and 4 h.

For testing of the antimicrobial efficacy through the up-conversion effect, the films with the inoculated side were additionally also incubated in the dark at room temperature for 0 h, 1 h, 2 h, 4 h.

All samples and references were tested in triplicate and with and without illumination over the incubation period.

The antimicrobial effect after the appropriate incubation time is detected via the determination of culturability by a contact test (FIG. 2).

For the testing of the culturability of B. subtilis, the films with the inoculated side, after the incubation time of 0 h, 1 h, 2 h, 4 h. were pressed against a sterile nutrient agar plate with a defined weight of 90±1 g for 60±5 s. The nutrient agar was then incubated under static conditions at 30° C. for 24±1 h. The bacterial colonies formed were qualitatively assessed visually.

### 2.3.3 Results of the Transfer Method

Any growth-inhibiting effect can be checked in the transfer method by a decrease in the culturability of B. subtilis. The results are collated in Table 4.

The culturability of the adherent bacteria on the surface of the plastic products showed a distinct reduction in reproduction with increasing incubation time. The phosphor Lu₂LiAl₃Si₂O₁₂:Pr brings about a significant decrease in the culturability of B. subtilis compared to the blank sample (plastic product without phosphor) and the plastic products incubated in the dark. This reduction can be measured under constant illumination even after incubation for 1 h. The drop in culturability increases until the incubation time of 4 h under constant illumination. The plastic products incubated in the dark do not show any reduction in culturability over the incubation period of 4 h. By virtue of the unchanged number of culturable bacteria over the period of 4 h, it is possible to show that the antimicrobial effect of the phosphor exists only in the illuminated state. The up-conversion effect thus exists here too. The plastic products additionally do not show any genuine contamination. As can be inferred from Table 4, all plastic products, in the case of use of 1% by weight or 5% by weight of the phosphor, show antimicrobial action in the illuminated state, whereas plastic products without phosphor or without illumination do not show any antimicrobial action.

TABLE 4
Antimicrobial efficacy of the plastic products

| | Antimicrobial effect | |
|---|---|---|
| Composition | Illuminated | Darkened |
| Blown PE film without phosphor | No | No |
| Blown PE film with 1% phosphor | Yes | No |
| Blown PE film with 5% phosphor | Yes | No |
| Shaped PP body without phosphor | No | No |
| Shaped PP body with 1% phosphor | Yes | No |
| Shaped PP body with 5% phosphor | Yes | No |
| UPES without phosphor | No | No |
| UPES with 1% phosphor | Yes | No |
| UPES with 5% phosphor | Yes | No |

1: A plastic product, comprising:
at least one plastic, and
at least one phosphor of the general formula (I)
Lu_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-e}Zr_{d}Hfₑ)ₐ₊₂ₙO₁₂ (I),
wherein
a=0-1, 1≥b>0, d=0-1, e=0-1, n=0-1, z=0-1, u=0-1, v=0-1,
with the proviso that u+v≤1 and d+e≤1, and
Ln is selected from the group consisting of praseodymium (Pr), gadolinium (Gd), erbium (Er), neodymium (Nd), and yttrium (Y).

2: The plastic product according to claim 1, wherein the at least one phosphor has been doped with praseodymium.

3: The plastic product according to claim 1, wherein the at least one phosphor is at least partially crystalline.

4: The plastic product according to claim 1, wherein the at least one phosphor is selected from compounds of the general formula (Ia)
(Lu_{1-x-y}YₓGd_{y})_{3-a-b-n}Ln_{b}(Mg_{1-z}Ca_{z})ₐLiₙ(Al₁₋ᵤ₋ᵥGaᵤScᵥ)₅₋ₐ₋₂ₙ(Si_{1-d-c}Zr_{d}Hfₑ)ₐ₊₂ₙO₁₂ (Ia),
wherein
a=0-1, 1≥b>0, d=0-1, e=0-1, n=0-1, x=0-1, y=0-1, z=0-1, u=0-1, v=0-1,
with the proviso that x+y≤1, u+v≤1, and d+e≤1, and
Ln is selected from the group consisting of praseodymium (Pr), erbium (Er), and neodymium (Nd).

5: The plastic product according to claim 1, wherein the at least one phosphor is a compound of the formula Lu_{2-b}Pr_{b}LiA₃Si₂O₁₂ with 1≥b>0.

6: The plastic product according to claim 1, wherein the at least one phosphor, on irradiation with electromagnetic radiation having lower energy and longer wavelength in the range from 2000 nm to 400 nm, emits electromagnetic radiation having higher energy and shorter wavelength in the range from 400 nm to 100 nm.

7: The plastic product according to claim 1, wherein the at least one phosphor has XRPD signals in the range from 17° 2Θ to 19° 2Θ and from 31° 2Θ to 35° 2Θ.

8: The plastic product according to claim 1, wherein the at least one phosphor has a particle size d50 of 0.1 to 100 μm.

9: The plastic product according to claim 1, wherein a proportion by mass of all phosphors is from 0.02% to <50.00%, based on a total mass of the plastic product.

10: The plastic product according to claim 1, wherein the at least one plastic is selected from the group consisting of thermoplastics and thermosets.

11: The plastic product according to claim 10, wherein
a) the thermoplastic is selected from the group consisting of acrylonitrile-butadiene-styrene (ABS), polyamide (PA), polylactate (PLA), poly(alkyl) (meth)acrylate, polymethylmethacrylate (PMMA), polycarbonate (PC), polyethylene terephthalate (PET), polyethylene (PE), polypropylene (PP), polystyrene (PS), polyether ether ketone (PEEK), polyvinyl chloride (PVC), cycloolefin polymers (COP), cycloolefin copolymers (COP), and thermoplastic elastomers (TPE), and/or
b) the thermoset is selected from the group consisting of diallyl phthalate resins (DAP), epoxy resins (EP), urea-formaldehyde resins (UF), melamine-formaldehyde resins (MF), melamine-phenol-formaldehyde resins (MPF), phenol-formaldehyde resins (PF), unsaturated polyester resins (UP, UPES), vinyl ester resins (VE), and polyurethanes (PU).

12: The plastic product according to claim 1, wherein a proportion by mass of all plastics is from >50.00% to 99.98%, based on a total mass of the plastic product.

13: The plastic product according to claim 1, wherein the plastic product has antimicrobial action against bacteria, yeasts, moulds, algae, parasites, and/or viruses.

14: The plastic product according to claim 1, wherein the plastic product is selected from the group consisting of moulding compounds, shaped bodies, mouldings, workpieces, semifinished products, finished products, granules, masterbatches, fibres, and films.

15: An article comprising and/or produced from the plastic product according to claim 1.

16: The plastic product according to claim 5, wherein in the formula Lu_{2-b}Pr_{b}LiAl₃Si₂O₁₂, b=0.02.

17: The plastic product according to claim 6, wherein an intensity of an emission maximum of the electromagnetic radiation having high energy and shorter wavelength is an intensity of at least 1·10³ counts/(mm²·s).

18: The plastic product according to claim 8, wherein the at least one phosphor has a particle size d50 of 0.1 to 5 μm.

19: The plastic product according to claim 9, wherein the proportion by mass of all phosphors is from 1.00% to 7.00%, based on the total mass of the plastic product.

20: The plastic product according to claim 11, wherein the thermoplastic elastomers are selected from the group consisting of thermoplastic polyamide elastomers, thermoplastic copolyester elastomers, thermoplastic elastomers based on olefins, thermoplastic styrene block copolymers, thermoplastic polyurethanes, thermoplastic vulcanizates, and crosslinked thermoplastic elastomers based on olefins.
